(19) United States
(12) Patent Application Publication
(10) Pub. No.: US 2012/0100927 A1
(43) Pub. Date: Apr. 26, 2012

(54) INHIBITING VIBRATION IN SPORTS EQUIPMENT AND HAND TOOLS

(76) Inventor: Martin John Lenzini, Suffolk (GB)

(21) Appl. No.: 12/736,543

(22) PCT Filed: Apr. 8, 2009
(86) PCT No.: PCT/GB2009/000921

§ 371 Date: Nov. 23, 2011

(30) Foreign Application Priority Data
Apr. 8, 2008 (GB) 0806319.0
Apr. 8, 2008 (GB) 0806321.6
Aug. 26, 2008 (GB) 0815465.0

(51) Int. Cl. A63B 53/00; A63B 49/00; B25D 1/12; A63B 59/00

(52) U.S. Cl. 473/318; 473/520; 473/521; 81/22

(57) ABSTRACT

During use of a golf club, the impact of the head of the club with a ball causes complex vibrations in the handle that are uncomfortable for the user and may adversely affect the force applied to and energy transferred to the ball. The invention aims to mitigate this problem by providing an end piece attached to an end of a shaft of the golf club thereby defining a tapered termination for an air column defined by said shaft.

This invention relates to the control of vibration in sports apparatus such as bats and clubs and particular golf clubs. During use of a golf club, the impact of the head of the club with a ball causes complex vibrations that may adversely affect the force applied to and energy transferred to the ball. The invention aims to mitigate this problem.

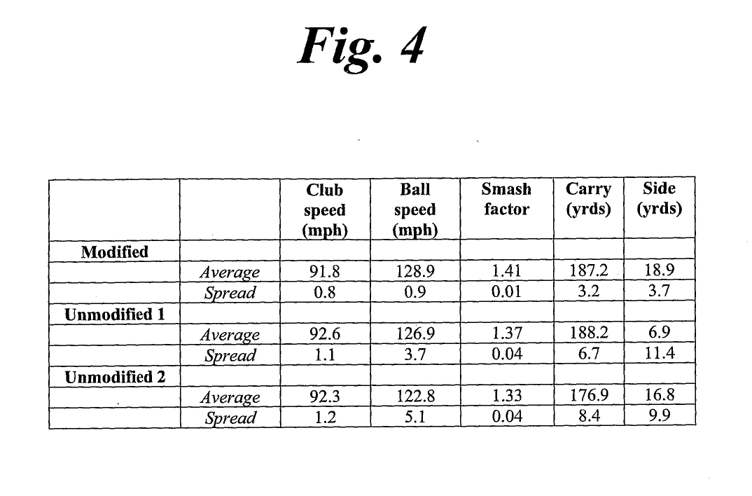

Patent specification US 2003/0220155 provides, with reference to FIGS. 4A and 4B, an analysis of the distribution of vibrational energy over a spectrum of frequencies and shows that high acoustic pressure occurs at a main peak that begins at about 6000 Hz equating with a wavelength of about 0.058 m (assuming the speed of sound to be 340 m/s. The top of the peak is somewhere in the region of 8 KHz equating with a wavelength of about 0.044 m.

This invention provides a sports club, bat, racquet or hand tool comprising a tubular shaft defining a column of gas and characterised by a step, discontinuity or taper spaced or extending from one end of the column by a distance such as to suppress reflection and/or encourage transmission of sound waves from that end.

It is conjectured that a discontinuity or step will serve to suppress reflections (and therefore encourage transmission of energy out of the shaft end) at a wavelength of four times the spacing from the end of the column. A series of such steps or discontinuities can be expected to do so at a corresponding series of wavelengths and a smooth continuously tapered shape can be expected to act similarly over a continuous range of frequencies. Therefore to suppress reflection at wavelengths of up to 0.044 m it is necessary for the spacing to be about 0.011 m i.e. around 1 cm; and to suppress reflection of wavelengths of up to 0.058 m it is necessary for the spacing to be about 0.0145 m i.e. around 1.5 cms. In practice a spacing of 0.5° has been shown to have a positive effect, though not a pronounced as with spacings over 1 cm. Spacing above 3 cm have not been tested, but is believed that the effect of longer spacing is unlikely to produce substantial improvements to performance, no further improvement is expected for a spacing over 6 cm.

The step or taper is preferably defined by an end piece attached to the end of the shaft. The end piece may be attached to either end of the shaft. Where it is attached to the end associated with the handle of the bat, club, racquet or hand tool, it acts to dampen vibrations transmitted into the hand of the user. Alternatively where the end piece is attached to the end shaft associated with the head of the club, bat or racquet it may improve the accuracy of the apparatus by dampening vibrations which could otherwise adversely affect the force applied to and energy transferred to a ball.

Where a tapered end piece is chosen the taper angle relative to the axis of the shaft is preferably below 45° and most preferably between 20° and 7.5°.

The end piece may be defined so as to provide a partially open ended air column. Where this is so, it is preferable that the area of the opening is at least 90% smaller than the area of the cross sectional area of the air column defined by the shaft and more preferably at least 98% smaller.

The invention will now be described by way of example with reference to the following figures in which:

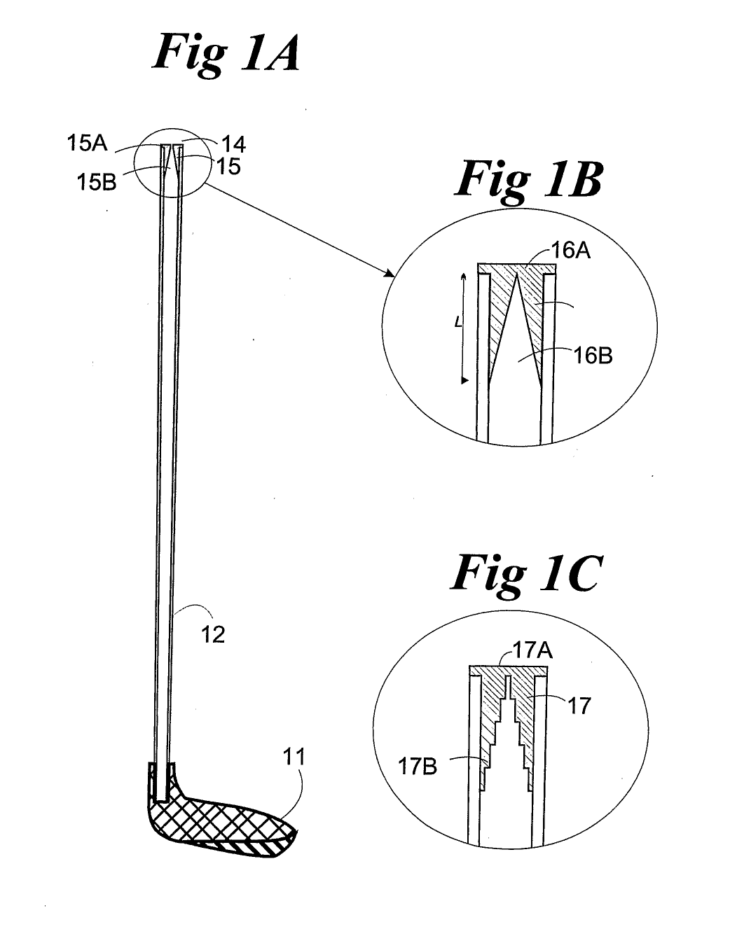

FIG. 1A is a vertical cross section through the vertical axis of the shaft of a golf club having an insert defining a discontinuity in the form of a taper;

FIGS. 1B and 1C are magnified views of the free end of the shaft illustrating variant designs of taper;

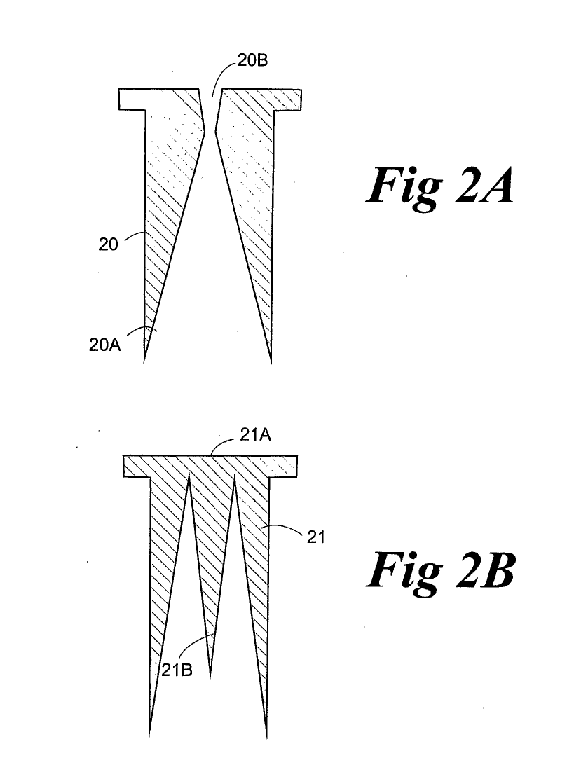

FIGS. 2A, and 2B, are axial cross sections of further alternative inserts designs;

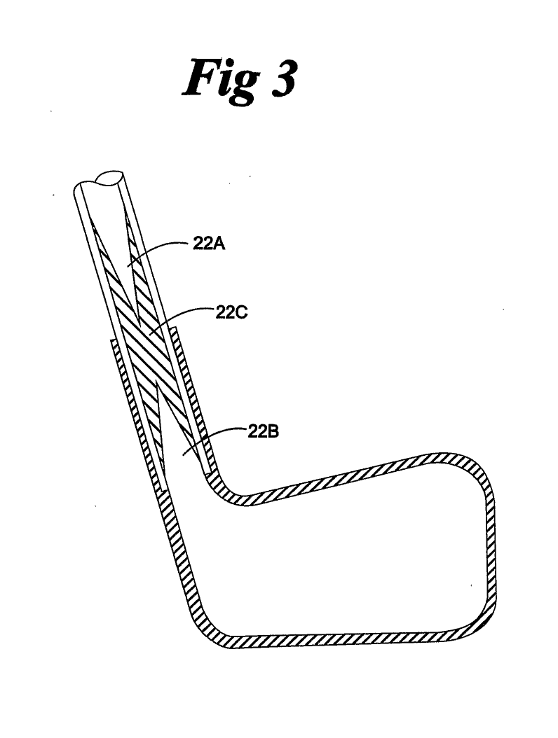

FIG. 3 is a cross section illustrating a further variant of insert located within a hosel of a golf club head; and

FIG. 4 is a chart of test data comparing golf clubs with and without the presence of an insert.

Referring to FIG. 1A, the illustrated golf club driver or “wood” comprises a head 11 carried at one end of a metal shaft 12. The shaft 12, as is conventional in golf clubs, is of tapered tubular construction, such as to define an air column, widening gradually from the end attached to the head 11 to the free end 14 which forms the handle. The free end 14 may also support a grip (not shown) which may take the form of a sleeve over the shaft. Located into the free end 14 of the shaft is an insert 15. The insert 15 defines at one end a circumferential lip 15A and a body which extends away from the lip with a slight narrowing taper to conform with the taper of the shaft. The insert is sized to be held snugly within the shaft by means of a resistance fit against the inner walls of the shaft, though in an alternative embodiment the insert may be adhered with adhesive. A bore 16 runs axially about the length of the insert 15. The bore 15B is tapered to be widest at the end opposite the lip 15A. The widened bore 15 is formed at the expense of the thickness of the insert wall such that the inserts wall has a wedge shaped profile when viewed in cross section.

The shaft 12 has at its free end 14 an internal diameter of 13 mm which corresponds to a cross sectional area of 132.7 mm². The bore of the insert tapers down such that the opening has a diameter less than 7 mm which corresponds to a cross sectional area of 38.49 mm² a 71% reduction in the surface area. However, it has been found that greatest performance is achieved where the opening has a diameter of 1 mm or less, equating to a reduction of 98% or more.

The bore is formed with a taper length (l) having a length between 1 cm and 6 cm. Effective to suppress wavelengths above 8 Khz and 1.4 Khz respectively. The inner diameter of the free end of a golf club shaft is generally between 13 mm-14.5 mm, and this leads to a taper angle of around 34° and 6.2° for taper lengths of 1 cm and 6 cm respectively. This substantially greater than the normal taper of the shaft which is usually 0.25°-0.5° about its length

FIG. 1B shows a variant insert 17 in which the free end is closed by a wall portion 17A with a conical bore 17B terminating at its narrowest point adjacent the wall. When inserted into the shaft 12 the insert 17 acts to occlude the air column.

The insert 17 of FIG. 1C is much like that of FIG. 1B except that the discontinuity is created by a series of steps 17B rather than a smooth taper.

Like insert 15 of FIG. 1A, insert 20 of FIG. 2A defines a bore 20A which runs the length of the insert 20. The bore 20A inwardly tapers as before but draws to its narrowest away from the free end of the insert. A reverse tapered bore 20B communicates with bore 20A at its narrowest point to provide a widened or flared opening at the free end of the insert 20.

FIG. 2B illustrates a further variant insert 21 comprising a projection 21B which extends from the closed end 21A of the insert substantially parallel to the axis of the insert. The free end of the projection 21B tapers to a point.

FIG. 3 illustrates another variant insert 22 defining two tapered bores 22A and 22B having the same taper length. Each bore 22A, 22B extends from either end of the insert 22 and terminates at a central region of the insert. Communication between the two bores is prevented by a wall portion 22C located between the bores 22A, 22B. the insert 22 is located into the hosel of a hollow headed golf club, the bores 22A, 22B, acting to dampen vibrations generated within the shaft and head respectively.

FIG. 4 provides test data of three, six iron golf clubs of which one has been modified by provision of an insert substantially as illustrated in FIG. 1B into the free end of the shaft.

In each case the average and spread data were taken from six shots taken with each of the three clubs. The average indicates the mean average of each of the six shots, the spread is indicative of the consistence between the shots.

Of significance is that even though the average club speed is lower than with the unmodified clubs, the ball speed is both higher and more consistent. This indicates that more of the energy from the swinging club is being transmitted to the golf ball.

Also of note is that the spread figures for Carry (distance travelled by ball through air). Side (side dispersion) are significantly lower with the modified club as compared the unmodified clubs suggesting that a ball struck using a modified club can be placed with greater accuracy than unmodified clubs.

Although the above description is directed to gold clubs, it is believed that invention may equally be applied to any other sporting apparatus which comprise an air or other fluid Column including base ball bats and tennis, badminton or squash racquets. Or to hand tools such as hammers, pick axes, forks, shovels etc.

It is envisaged that in most cases the air column will have a circular crosses section and thus the end piece will have a circular cross section however, other cross section may be used where the column takes forms other than cylindrical.

In alternative embodiments it is envisaged that the end piece need not take the form of an insert but could lie adjacent the end of the column or be supported by a sleeve around the column, for example it could be formed integrally with the grip of the shaft.

1. A sports club, bat, racquet or hand tool comprising a tubular shaft defining a column of gas and having a step, discontinuity or taper spaced or extending from one end of the column by a distance such as to suppress reflection and/or encourage transmission of sound waves from that end.

2. A golf club shaft according to claim 1 wherein the said distance is in excess of about 0.01 m.

3. A golf shaft according to claim 2 wherein the said distance is in excess of about 0.015 m

4. A golf shaft according to claim 3 wherein the said distance is between 0.01 m and 0.06 m.

5. A sports club, bat, racquet or hand tool according to claim 1 wherein the step or taper is defined by an end piece attached to the end of the shaft.

6. A sports club, bat, racquet or hand tool according to claim 1 wherein the said end of the air column is closed.

7. A sports club, bat, racquet or hand tool according to claim 1 wherein the said end of the column is partially open.

8. A sports club, bat, racquet or hand tool according to claim 7 wherein an opening to the air column having an area which is at least 90% smaller than the area of air column as defined by the shaft.

9. A golf club according to claim 1 further having a hollow head attached to one end of the shaft.

10. An end piece for a sports club, bat, racquet or hand tool according to claim 1.

11. A sports club, bat or racquet, hand tool comprising a tubular shaft defining an air (hollow) column, an end piece attached to an end of the shaft and defining a tapered termination for the air column.

12. A vibrational tuning device comprising an elongated chamber having one or a plurality of sides and a tapering internal reduction in area of said chamber to an extent that part the internal wave energy is reflected back before it reaches the end of said chamber to restrict the amount of energy transferred to the surround or end of said chamber.
